(19) United States
(12) Patent Application Publication
(10) Pub. No.: US 2017/0116180 A1
(43) Pub. Date: Apr. 27, 2017

(54) DOCUMENT ANALYSIS SYSTEM

(71) Applicant: J. Edward Varallo, (US)

(72) Inventors: J. Edward Varallo, Grafton, MA (US); Richard B. Hardeman, Sarasota, FL (US)

(21) Appl. No.: 15/331,382

(22) Filed: Oct. 21, 2016

Related U.S. Application Data
(60) Provisional application No. 62/245,469, filed on Oct. 23, 2015.

(51) Int. Cl. G06F 17/27; G06F 17/30

(52) U.S. Cl. CPC G06F 17/2735; G06F 17/30699; G06F 17/276; G06Q 50/18

(57) ABSTRACT

An analysis device includes a controller having a memory and a processor. The controller is configured to receive a source file from a user device, the source file including key text items. The controller is configured to store each line of the source file as a line information entry and a text information entry in a source file table. The controller is configured to apply a filter criteria to at least a portion of each text information entry of the source file table to identify one of a retained text entry and an excluded text entry. The controller is configured to provide, as the key text items, a result file listing each retained text entry.

### RELATED APPLICATIONS

This patent application claims the benefit of U.S. Provisional Application No. 62/245,469, filed on Oct. 23, 2015, entitled “Document Analysis System,” the contents and teachings of which are hereby incorporated by reference in their entirety.

### BACKGROUND

Stenographic court reporters make a verbatim record of spoken English, typically testimony in a courtroom, deposition, or hearing, using a Stenograph machine. The Stenograph machine is typically connected to a laptop computer and the stenographer's keystrokes, i.e., the shorthand code, are captured in an electronic file on the laptop. Either following a stenography session or in real time, the stenographer can transcribe the shorthand file into translated (e.g., English) text using computer-assisted transcription (CAT) software which uses the stenographer's own dictionary of shorthand strokes (e.g., termed the “personal dictionary” herein). The personal dictionary is typically configured as a look-up table that matches steno code with the English equivalent, thus producing translated English text.

In order to prepare for a given stenography session or job, the stenographer typically configures his personal dictionary to include job-specific vocabulary, such as proper names, terms of art, acronyms, and technical jargon, by creating user-defined shorthand code to represent each particular term.

Prior to a job, the stenographer often acquires documents which have been generated in the course of the litigation, typically transcripts of prior depositions or pleadings filed with the court, all of which necessarily contain vocabulary peculiar to a forthcoming stenography session. Such documents are vital source material for purposes of the stenographer's preparation (e.g., termed “prep material” herein). For example, in the case where the session involves a deposition relating to the field of biotechnology, the user can review the transcription document of a previous deposition in the biotechnology-related matter. This can include a review for certain technical words or phrases, such as within the field of biotechnology, as well as for proper nouns, that occur in the document at a rate considered frequent enough to warrant inclusion in the stenographer's personal dictionary. After identifying these technical words/phrases, as well as the proper names, the stenographer adds them, as well as the associated steno keystrokes, to the stenographer's personal dictionary.

By predefining uncommon words, phrases, and names with particular shorthand keystrokes in the stenographer's personal dictionary, the stenographer can efficiently produce accurate English text translations even of esoteric terms of art, technical jargon, and case-specific proper names in real time. In such a case, the English text appears on the computer screen immediately after the stenographer has stroked the corresponding steno code on the Stenograph keyboard.

### SUMMARY

Modern litigation practice has changed the court reporter/stenographer's traditional role. Stenographers were, in the past, hired to record testimony in a deposition, hearing, or trial, and to provide a transcript thereof in due course, typically several weeks following the stenography session. Today, since CAT software allows for substantially instantaneous translation from shorthand code into English text, which can then be displayed typically on an attorney's laptop computer or other electronic device during a stenography session, professional court reporters who possess the requisite skill are in demand. Nevertheless, a highly skilled stenographer can only produce accurate, instantaneous voice-to-text real time translations of shorthand code that are already extant in his personal dictionary. Hence, preparation beforehand is vital for a stenographer, so that obscure terminology and case-specific vocabulary can be input into his personal dictionary in order to afford accurate English text translations at an upcoming stenography session.

Conventional stenographic job preparation suffers from a variety of deficiencies. For example, it can be time consuming for the stenographer to read through and review prep material documents, such as depositions or court documents, to find uncommon words, phrases, and names to add to his or her personal dictionary. Further, the stenographer may overlook certain words, phrases, and proper names of interest during the review of the prep material documents and, as a result, not include these elements in the stenographer's dictionary. This can limit the stenographer's efficiency during a job.

By contrast to conventional stenographic job preparation strategies, embodiments of the present innovation relate to a document analysis system. In one arrangement, the document analysis system is configured to analyze relatively large source files, such as prep material documents including court transcripts or depositions, and to generate a listing of key text items such as a list of words, acronyms, and multiword phrases that are unique to the source file. The listing of key text items or results file can provide a substantially concise overview of job-specific vocabulary to be utilized by the court reporter professional as part of his future assignment (i.e., when the assignment involves the same court case or subject-matter litigation) The listing of the words/acronyms/phrases in the results file can be arranged or ordered alphabetically or by frequency, thus providing quick identification of the most frequently occurring vocabulary. Such a listing allows the stenographer to update his personal dictionary prior to a stenography session, thereby aiding in the stenographer's efficiency during the session. In one arrangement, the document analysis system is configured to allow the professional to view each word, acronym, or phrase listed in the results file in the context presented in the original text file.

In one arrangement, the innovation relates to a method for providing key text items of a source file in an analysis device. The method includes receiving, by the analysis device, the source file, the source file including key text items. The method includes storing, by the analysis device, each line of the source file as a line information entry and a text information entry in a source file table. The method includes applying, by the analysis device, a filter criteria to at least a portion of each text information entry of the source file table to identify one of a retained text entry and an excluded text entry. The method includes providing as the key text items, by the analysis device, a result file listing each retained text entry.

In one arrangement, the innovation relates to an analysis device includes a controller having a memory and a processor. The controller is configured to receive a source file from a user device, the source file including key text items. The controller is configured to store each line of the source file as a line information entry and a text information entry in a source file table. The controller is configured to apply a filter criteria to at least a portion of each text information entry of the source file table to identify one of a retained text entry and an excluded text entry. The controller is configured to provide, as the key text items, a result file listing each retained text entry.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a document analysis system, according to one arrangement.

FIG. 2 illustrates a source file table generated by an analysis device of the document analysis system of FIG. 1, according to one arrangement.

FIG. 3 illustrates the generation of a string level file by the analysis device of the document analysis system of FIG. 1, according to one arrangement.

FIG. 4 illustrates a summary file generated by the analysis device of the document analysis system of FIG. 1, according to one arrangement.

FIG. 5 illustrates an example of a graphical user interface provided to a user device of the document analysis system, according to one arrangement.

FIG. 6 illustrates an example of a context output provided by the document analysis system, according to one arrangement.

### DETAILED DESCRIPTION

Embodiments of the present innovation relate to a document analysis system. In one arrangement, the document analysis system is configured to analyze relatively large source files, such as prep material documents including court transcripts or depositions, and to generate a listing of key text items such as a list of words, acronyms, and multiword phrases that are unique to the source file. The listing of key text items or results file can provide a substantially concise overview of job-specific vocabulary to be utilized by the court reporter professional as part of his future assignment (i.e., when the assignment involves the same court case or subject-matter litigation). The listing of the words/acronyms/phrases in the results file can be arranged or ordered alphabetically or by frequency, thus providing quick identification of the most frequently occurring vocabulary. Such a listing allows the stenographer to update his personal dictionary prior to a stenography session, thereby aiding in the stenographer's efficiency during the session. In one arrangement, the document analysis system is configured to allow the professional to view each word, acronym, or phrase listed in the results file in the context presented in the original text file.

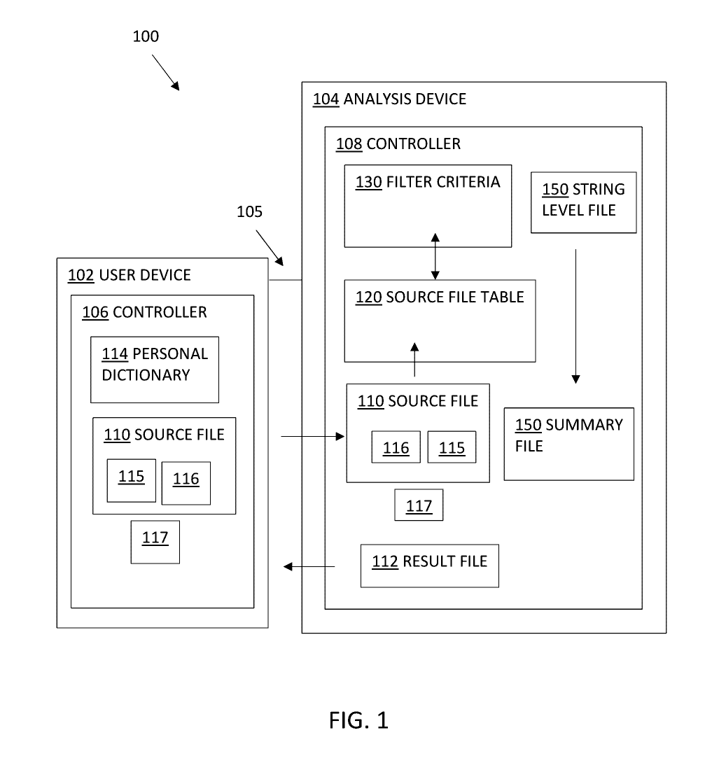

FIG. 1 illustrates an example of a document analysis system 100, according to one arrangement. As illustrated, the document analysis system 100 includes a user device 102 and an analysis device 104.

The user device 102 includes a controller 106, such as a memory and a processor, and can be configured in a variety of ways. For example, the user device 102 can be configured as a mobile phone (e.g., smartphone), a tablet device, a laptop computer, or other computerized device. The user device 102 is disposed in electrical communication with the analysis device 104. For example, the user device 102 can be disposed in electrical communication with analysis device 104 via a wired or wireless network 105, such as a local area network (LAN) or a wide area network (WAN).

The analysis device 104 includes a controller 108, such as a memory and a processor, and can be configured in a variety of ways. For example, the analysis device 104 can be a computerized device, such as a server device. Alternately, the analysis device 104 can be configured as part of the user device 102. In such a case, the user device 102 and the analysis device 104 form part of a single device, such as a computerized device operated by the user.

During operation, the analysis device 104 is configured to analyze a source file 110 provided by the user device 102 and to generate a result file 112 that includes particular words, acronyms, and/or phrases that can, with a degree of likelihood, come up during a stenography session or job. The result file 112 allows a user, after review, to add any or all of the words, acronyms, and/or phrases to the stenographer's personal dictionary 114 stored by the user device controller 106, along with a corresponding set of user-defined keystrokes or shorthand code.

The following provides a description of an example operation of the document analysis system 100, according to one arrangement.

In one arrangement, the analysis device 104 receives the source file 110 for analysis where the source file 110 includes key text items 115.

For example, assume a user of the user device 102 is a stenographer who wants to prepare his stenographer's dictionary 114 for an upcoming stenography session, such as a deposition. Prior to the session, the user receives the source file 110, such as an electronic transcript of a previous deposition, court document, or a research document, which can contain key text items 115 such as names, proper nouns, acronyms, or terms of art that could be used in an upcoming stenography session. While the source file 110 can be formatted in a variety of ways, in one arrangement, the source file 110 is formatted as a text (*.TXT) document. In the case where the source file 110 is configured in another format (e.g., *.PDF, *.DOC) the user device 102 is configured to convert the format of the source file 110 to a text format.

Next, the user device 102 is configured to transmit the source file 110 to the analysis device 104 via the network 105. In one arrangement, the user device 102 provides the source file 110 to the analysis device 104 along with source file information 116, such as user identification information, job identification information. In one arrangement, in response to receiving the source file 110, the analysis device 104 is configured to provide a confirmation response to the user device 102. For example, in the case where the analysis device 104 provides analysis of the source file 110 for a fee, the analysis device 104 can transmit a receipt to the user device 102 regarding a monetary charge for the analysis.

After receiving the source file 110, the analysis device 104 is configured to store the source file 110 in a transient memory location (e.g., a temporary storage location) of the controller 108. The analysis device 104 is further configured to extract each line from the source file 110 and store each line of the source file 110 as a line information entry 124 and a text information entry 126 in a source file table 120, such as a relational data base.

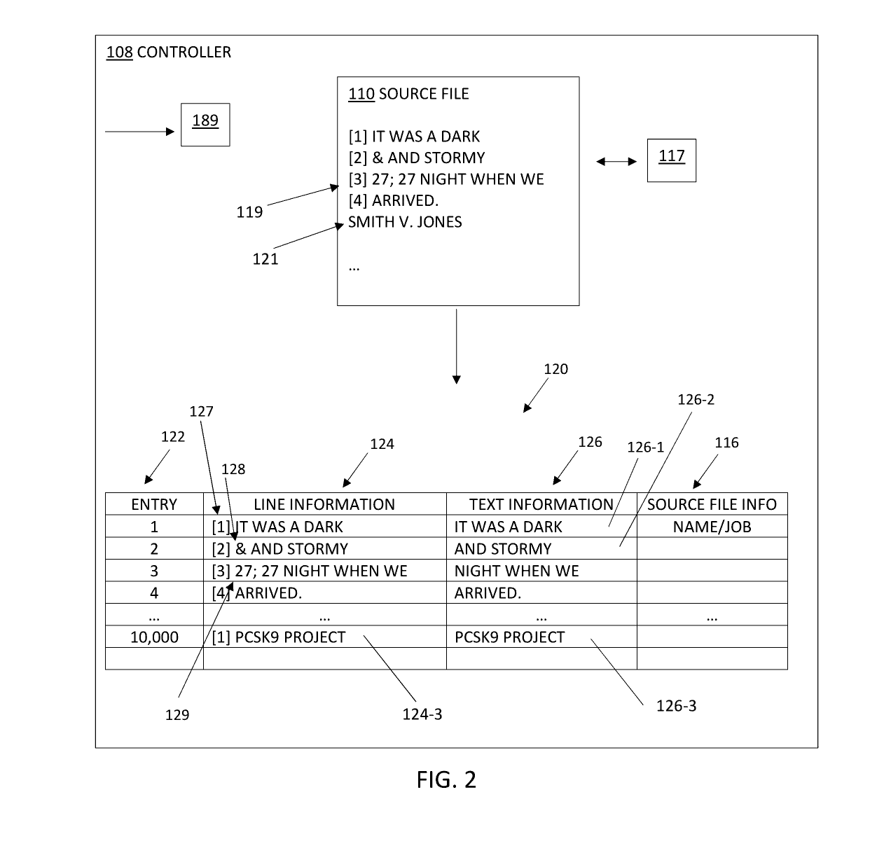

While the source file table 120 can be configured in a variety of ways, an example of the table 120 is provided in FIG. 2. As shown, the source file table 120 includes a table entry identifier 122 associated with each line of the source file 110, line information 124 associated with each line of the source file 110, and text information 126 associated with each line of the source file 110. The source file table 110 can also include source file information 116, such as user information or job information to identify the user or job associated with a particular analysis.

In one arrangement, during operation, assume the case where the analysis device 104 has received the source file 110 having lines 119. As the analysis device 104 reads or extracts each line 119 from the source file 110, the analysis device 104 writes or stores each line 119 as a line information entry 124 in the source file table 120. As indicated, each line information entry 124 can include all information associated with a particular line of text in the source file 110. For example, the content of each entry in the line information column 124 can include the text from the corresponding line of the source file 110 as well as the line number 127, any hidden characters 128, page information 129, or timestamp information included therein.

In one arrangement, the analysis device 104 is further configured to identify the non-textual information of each line information entry 124 of the source file 110, remove the identified non-textual information (e.g., line number, page number etc.) from the line of the source file 110, and store the text-only information as a text information entry 126 in the source file table 120. For example, as illustrated in FIG. 2, the second line 119 of the source file 110 recites “[2] & AND STORMY”. As the analysis device 104 reads the line 119 from the source file 110, the analysis device 104 is configured to discern textual information (e.g., letters) from non-textual information. As such, the analysis device 104 can identify the element “[2]” as a line number 127 and the element “&” as a hidden characters 128 (i.e., as being non-textual elements). Accordingly, the analysis device 104 removes these elements 127, 129 from the second line 119 and stores the remaining text in the line, “AND STORMY” as the text information entry 126-2 (i.e., absent the identified non-textual information).

In one arrangement, the analysis device 104 is configured to review the source file 110 to detect the presence of a running header. A running header can include a phrase that occurs in the source file 110, such as in the top margin of the source file, which is repeated from page to page. For example, with reference to FIG. 2, assume the source file 110 includes the phrase “SMITH v. JONES” at line 121 as a running header. The user of the user device can identify this phrase as a running header and, as indicated in FIG. 1, can forward header information 117 to the analysis device 104 for use in identifying the phrase as a running header.

During operation, as the analysis device 104 reads each line of the source file 110 the analysis device 104 compares each line of the source file 110 with the header information 117. When the analysis device 104 detects that a line of the source file 110, such as line 121, corresponds to the header information 117, the analysis device 104 refrains from storing the line of the source file 110 as a line information entry 124 or as a text information entry 126 in the source file table 126. With such a configuration, the analysis device 104 can maintain the continuity of text and phrases across page breaks without including extraneous information, such as running header information. This can increase the accuracy of key word detection provided by the analysis device 104 during operation.

In one arrangement, once the analysis device 104 has identified and stored each line of the source file 110 as a line information entry 124 and a text information entry 126 as part of the source file table 120, the analysis device 104 is configured to delete the source file 110 from the transient memory and to store the source file table 120 as a representation of the source file 110. As provided above, the source file 110 can be an electronic transcript of a previous deposition, court document, or a research document. As such, the document may contain confidential information. Deletion of the source file 110 by the analysis device 104 limits or prevents further distribution of the source file 110, thereby maintaining a level of confidentiality with respect to the source file 110.

In on arrangement, after developing the source file table 120, the analysis device 104 maintains the source file table 120 in a queue to await further processing and analysis. For example, over time, a job monitoring robot (e.g., Crontab) reviews a job queue associated with the analysis device 104. If the job identified in the analysis instruction 132 is present, the analysis device 104 begins analysis of the source file table 120.

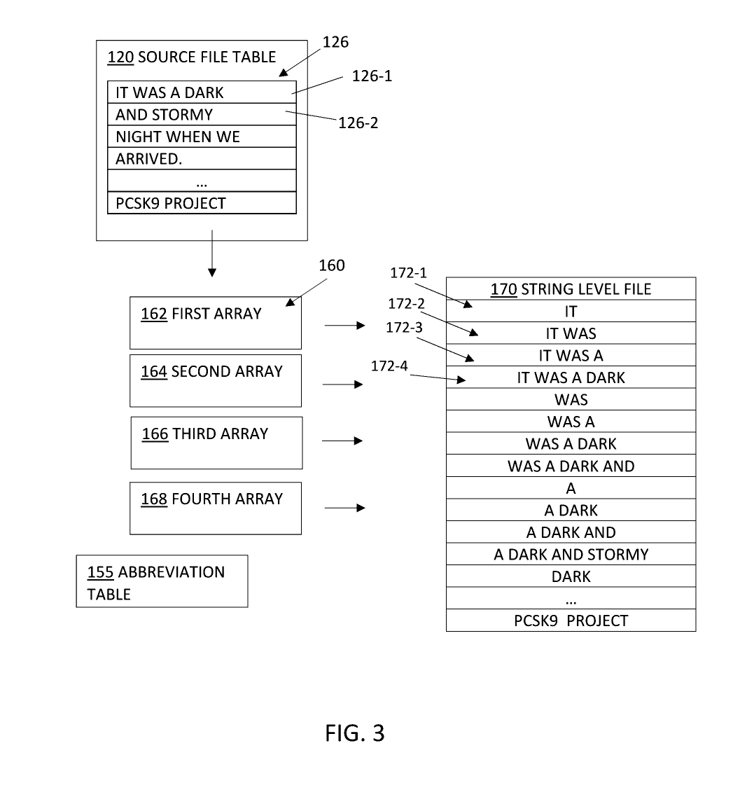

As part of the analysis process, the analysis device 104 is configured to detect the presence of key text items in the source file 110 based upon a review of the source file table 120. For example, with reference to FIG. 3, the analysis device 104 is configured to review each entry of the text information entry column 126 of the source file table 120 for separate strings and to write the strings into corresponding arrays 160. The analysis device 104 writes the content of the arrays 160 into entries of a string level file 170. As the analysis device 104 repeats this process for the strings included in the text information entry column 126, the analysis device 104 builds the string level file 170 for further analysis.

In one arrangement, the analysis device 104 is configured to read each string from the text information entry column 126 one string at a time and to develop four separate string arrays having one, two, three, or four string groupings. With such a configuration, the analysis device 104 develops groupings of words that represents up to approximately one second of speech. This corresponds to the amount of time a stenographer can typically listen to verbal communication and comfortably transcribe the speech to text. As will be described below, development of the string arrays allows the analysis device 104 to build a database of both single words and multi-word phrases associated with the source file 110.

For example, during operation the analysis device 104 is configured to identify the first string of the first entry 126-1 of the text information column 126 (“IT”) to write the first string from the text information entry 126-1 “IT” into a first array 162. The analysis device 104 is configured to then identify the first string and a second string (“IT WAS”) from the text information entry 126-1 and write the first string and second string into a second array 164. It is noted that the analysis device 104 is configured to identify the presence of a space as identifying adjacent strings. Next, the analysis device 104 is configured to then identify the first string, the second string, and a third string (“IT WAS A”) from the text information entry 126-1 and write the first, second and third strings into a third array 166. Next, the analysis device 104 is configured to identify the first string, the second string, the third string, and a fourth string (“IT WAS A DARK”) from the text information entry 126-1 and write the first, second, third, and fourth strings into a fourth array 168. The analysis device 104 then transfers the content of the arrays 162, 164, 166, and 168 to corresponding entries 172-1, 172-2, 172-3, and 172-4 in the string level file 170.

The analysis device 104 is then configured to restart the process after incrementing the starting point from the first string to the second string. For example, with continued reference to FIG. 3, the analysis device 104 is configured to identify the second string “WAS” from the text information entry 126-1 as a first string and to write the first string “WAS” into the first array 162. The analysis device 104 is then configured to identify and write the first and second strings “WAS A” into the second array 164, the first, second, and third strings “WAS A DARK” into the third array 166, and the first, second, third, and fourth strings “WAS A DARK AND” into the fourth array 168. It is noted that with the identification of the fourth string “AND”, the analysis device 104 is configured to review both the first text information entry 126-1 and the second text information entry 126-2, which subsequently follows the first entry 126-1. The analysis device 104 then transfers the content of the arrays 162, 164, 166, and 168 to corresponding entries in the string level file 170 and repeats the process until it reaches the end of the text information entry column 126 of the source file table 120.

With continued reference to FIG. 3, in the case where the analysis device 104 encounters punctuation in the text information entry column 126, the analysis device 104 can be configured to consult an abbreviation table 155 to determine an attribute associated with the punctuation. In one arrangement, the punctuation table 155 identifies certain types of punctuation as being associated with an abbreviation, rather than being associated with the end of a sentence. For example, the punctuation table 155 can be configured to identify the string “Mr.” or “Mrs.” as abbreviations. During a review of a string or a set of strings, if the analysis device 104 detects correspondence between a punctuation element detected in the string and an entry in the punctuation table 155, the analysis device 104 is configured to proceed with the review of the entries in the text information column 126. Therefore, the phrase “Mr. Jones shouted.” includes a first period to indicate an abbreviation and a second period to indicate the end of a sentence. Based upon a correspondence between the string “Mr.” in the phrase and an entry for “Mr.” in the punctuation table 155, the analysis device 104 is configured to proceed with the review of the entries in the text information column 126 (e.g., the strings “Jones shouted”).

In the case where the analysis device 104 detects a lack of correspondence between a punctuation element detected in the string and an entry in the punctuation table 155, the analysis device 104 is configured to discontinue reading of each string from the text information entry column 126 and to transfer the content of the arrays 162, 164, 166, and 168 to corresponding entries in the string level file 170, thereby clearing the arrays 162, 164, 166, and 168. Further, the analysis device 104 is configured to restart the analysis of the text information column 126 with the string following the punctuation element (e.g., the string following “shouted.”).

Next, the analysis device 104 is configured to summarize the total number of occurrences of the words and phrases identifies in the string level file 170. In one arrangement, the analysis device 104 is configured to identify a number of identical occurrences of an entry in the string level file 170. With reference to FIG. 3, taking the first entry 172-1 “IT” as an example, the analysis device 104 reviews the string level file 170 and counts the number of occurrences of the string “IT” in the string level file 170.

In one arrangement, when counting the number of occurrences of a string, the analysis device 104 is configured to subsume shorter phrases into a longest form for a given phrase. For example, the analysis device 104 is configured to review the included group of entries to determine if any of the phrases, while not identical, begin with the same words. Assume the case where the string level file 170 includes a number of occurrences of the phrase “United States” and a number of occurrences of the phrase “United States of America”. In the case where the analysis device 104 detects that the shorter phrase (e.g., “United States”) occurs fewer times than the longer phrase (e.g., “United States of America”), the analysis device 104 can determine that the shorter phrase is equivalent to the longer phrase and can subsume the shorter phrase into its longer form. In the case where the analysis device 104 detects that the shorter phrase (e.g., “United States”) occurs as many or more times than the longer phrase (e.g., “United States of America”), the analysis device 104 can determine that the shorter phrase is distinct from the longer phrase and will refrain from subsuming the shorter phrase into its longer form.

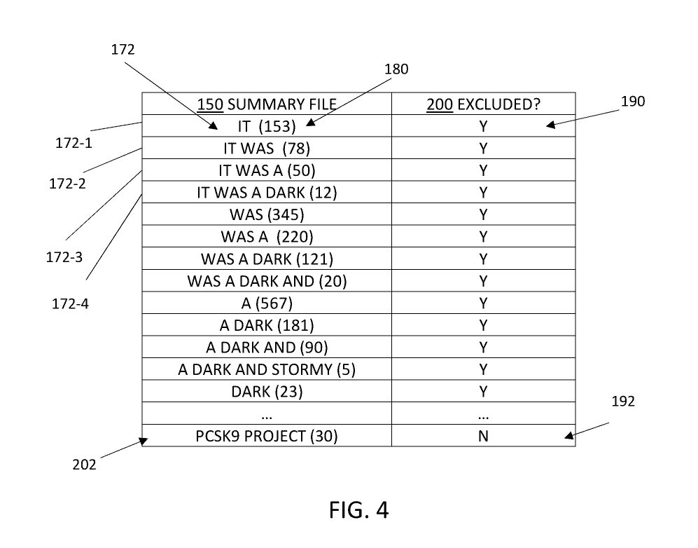

In one arrangement, after detecting the number of occurrences of the strings in the string level file 170, with reference to FIG. 4, the analysis device 104 is configured to generate a summary file 150 listing each entry 172 from the string level file 170 and the associated number of identical occurrences of the entry 180 in the string level file 170. For example, taking the first entry 172-1 “IT” as an example, the summary file 150 identifies 153 occurrences of the string in the string level file 170. In one arrangement, the analysis device 104 is configured to output the summary file 150 to an end user, such as via a display or electronic file for review. It is noted that in another arrangement, analysis device 104 is configured to generate the summary file 150 as the analysis device 104 detects the number of occurrences of the strings in the string level file 170.

Next, returning to FIG. 1, the analysis device 104 is configured to apply a filter criteria 130 to at least a portion of each text information entry 126 of the source file table 120 to identify one of a retained text entry and an excluded text entry. As will be described below, application of the filter criteria 130 allows the analysis device 104 to detect key text items 115 present within the source file 110.

The filter criteria 130 can be configured in a variety of ways. For example, the filter criteria 130 can include a listing of pre-defined terms to be excluded as a key text item 115. For example, the filter criteria 130 can identify terms such as “a,” “the,” and “and” as being excluded as key text items 115. Further, the filter criteria 130 can identify a particular phrase as being excluded as a key text item 115 if the phrase has a particular starting or ending word or if the phrase includes a particular wildcard. For example, the filter criteria 130 can identify phrases starting with the term “and,” ending with the term “and,” or including the term “and” as a wildcard within a phrase as being excluded as a key text item 115. Additionally, in one arrangement, the filter criteria 130 can be updated by the user or by a systems administrator to include new or modified rules or attributes.

In use, and with reference to FIG. 4, the analysis device 104 is configured to apply the filter criteria 130 to the entries of the summary file 150 to identify at least one of a retained text entry 192 and an excluded text entry 190. For example, assume the filter criteria 130 includes a rule that excludes entries that begin with the word “it”. When the analysis device 104 applies this filter criteria 130 to the entries 172-1 through 172-4, the analysis device 104 detects a correspondence with each entry 52-1 and the filter criteria 130. As a result, the analysis device 104 identifies the entries as being an excluded text entry 190 and provides such an indication in a corresponding exclusions column 200.

When the analysis device 104 applies this filter criteria 130 to the entries of the summary file 150 and does not identify an entry as an excluded text entry 190, the analysis device 104 is configured to identify such an entry as a retained text entry 192. For example, as a result of identifying the entries in the summary file 150 as being excluded text entries 190, the analysis device 104 separates the words and phrases of the summary file 150 into excluded text entries 190 and retained text entries 192 (i.e., where the retained text entry group is defined as the entries in the summary file 150 that were not excluded during the application of the filter criteria 130). For example, with reference to FIG. 4, assume the case where the filter criteria 130 does not include a rule that excludes the phrase PCSK9 Project. In such a case, the analysis device 104 would not identify entry 202 “PCSK9 Project”, as being an excluded text entries 190.

In one arrangement, the analysis device 104 is then configured to review the retained text entries 192 from the summary file 150 for key word entries. For example, the analysis device 104 is configured to review the retained text entries 192 for text having capital letters, numbers in the word, or acronyms (e.g., IBM; LL12ABX; Mr. Jones; iPad). When the analysis device 104 identifies the text as having capital letters (i.e., proper noun), numbers, or acronyms, the analysis device 104 defines the text as a key text item 115.

Application of the rules 130 to the entries of the summary file 150, therefore, limits the total number of words and phrases presented to the end user as a key text item 115.

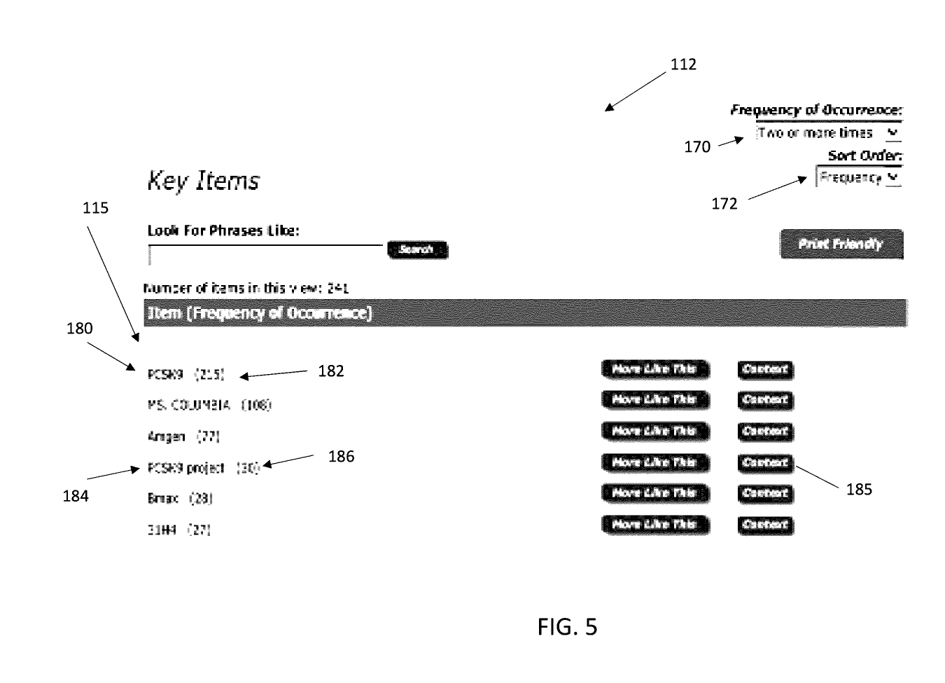

After the analysis device 104 has identified the key text items 115 in the summary file 150, the analysis device 104 is configured to generate a result file 112 for provision to the user device 102. For example, FIG. 5 illustrates the result file 112 presented to the user device 102 as part of a graphical user interface (GUI) that includes, as the key text items 115, a lists of words, acronyms, and multiword phrases that are unique to the source file 110 as well as the number of occurrences of the items in the summary file 150. For example, the key word PCSK9 180 is shown to occur with a frequency 182 of 215 within the source file 110 while the key phrase PCSK9 Project 184 is shown to occur with a frequency 186 of 30 within the source file 110.

In one arrangement, the GUI includes controllers that allow the user to adjust the display of the key text items 115 as part of the GUI. For example, the GUI can include a frequency filter 170 that allows the user to view key text items 115 that occur more than a selected number of times in the summary file 150. The GUI also can include a sort order controller 172 that allows the user to display the key text items 115 in either descending frequency order, as shown, or alphabetically.

In one arrangement, the result file 112 allows the end user to view key words and key phrases filtered from the source file 110 in the context presented in the original source file 110. For example, the analysis device 104 can include a link between each key text item 115 provided by the GUI and corresponding entries in the line information column 124 of the source file table 120.

With continued reference to FIG. 5, the GUI includes a context control 185 associated with each key text item 115. In response to an end user activating a context control 185 (e.g., clicking on the context control 185 using a mouse), the analysis device 104 is configured to receive a context command associated with a retained text entry of the result file 112. For example, assume a user wants to view the context of the phrase PCSK9 Project 184. By activating the associated context control 185, with reference to FIG. 2, the user device 102 transmits the context command 189 to the analysis device 104. In response, the analysis device 104 accesses a text information entry 126 in the source file table 120 associated with the retained text entry of the result file 112. For example, the analysis device 104 can review the source file table 120 to identify an entry in the text information entry column 126, in this case entry 126-3, which corresponds with the selected entry from the result file 112.

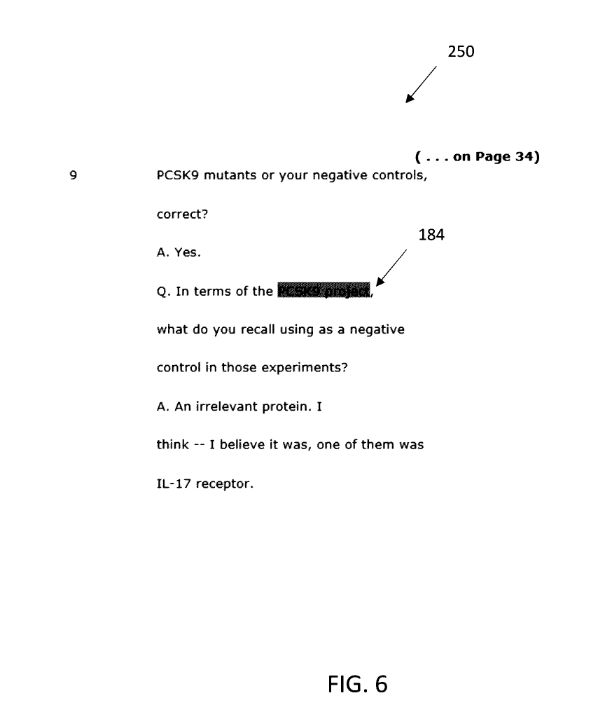

Next, the analysis device 104 is configured to access the line information entry 124-3 in the source file table 120 associated with the text information entry 126-3 and provide context output associated with the line information entry 124-3, the context output including the line information entry and at least one of a previous line information entry and a subsequent line information entry of the source file table. For example FIG. 6 illustrates an example of context output 250 showing the key phrase PCSK9 project 184, as well line information entries occurring before and after the key phrase.

When the user selects a hyperlink 170, such as associated with the word “PCSK9” the analysis device 104 is configured to identify the occurrences of the term line within information column 124 and present context output 180 of the term, as illustrated in FIG. 6.

Accordingly, the system 100 allows a user to obtain important vocabulary relevant to the job from a document without requiring the user to read through the document. Further, system 100 is configured to filter words, phrases, and proper names of interest during in a substantially accurate manner, which can substantially add to the stenographer's performance efficiency during a stenography session.

While various embodiments of the innovation have been particularly shown and described, it will be understood by those skilled in the art that various changes in form and details may be made therein without departing from the spirit and scope of the innovation as defined by the appended claims.

What is claimed is:

1. In an analysis device, a method for providing key text items of a source file, comprising:
receiving, by the analysis device, the source file, the source file including key text items;
storing, by the analysis device, each line of the source file as a line information entry and a text information entry in a source file table;
applying, by the analysis device, a filter criteria to at least a portion of each text information entry of the source file table to identify one of a retained text entry and an excluded text entry; and
providing as the key text items, by the analysis device, a result file listing each retained text entry.

2. The method of claim 1, wherein storing each line of the source file as a line information entry and a text information entry in a source file table, comprises:
identifying, by the analysis device, non-textual information in a line of the source file;
removing, by the analysis device, the identified non-textual information from the line of the source file;
storing, by the analysis device, the line of the source file as the line information entry in the source file table; and
storing, by the analysis device, the line absent the identified non-textual information as the text information entry in a source file table.

3. The method of claim 1, further comprising:
receiving, by the analysis device, header information associated with the source file;
comparing, by the analysis device, each line of the source file with the header information; and
when a line of the source file corresponds to the header information, refraining from storing the line of the source file as a line information entry and as a text information entry in the source file table.

4. The method of claim 1, comprising:
writing, by the analysis device, at least one string of the text information entry into at least one array; and
writing, by the analysis device, the contents of the at least one array to a corresponding entry of a string level file.

5. The method of claim 4, wherein writing the at least string into the at least one array comprises:
writing, by the analysis device, a first string from the text information entry into a first array;
writing, by the analysis device, the first string and a second string from the text information entry into a second array;
writing, by the analysis device, the first string, the second string, and a third string from the text information entry into a third array;
writing, by the analysis device, the first string, the second string, the third string, and a fourth string from the text information entry into a fourth array; and
writing, by the analysis device, the contents of the first array, the second array, the third array, and the fourth array into corresponding entries of the string level file.

6. The method of claim 5, comprising repeating, by the analysis device:
identifying the second string from the text information entry as a first string of the text information entry;
writing the first string from the text information entry into a first array;
writing the first string and a second string from the text information entry into a second array;
writing the first string, the second string, and a third string from the text information entry into a third array;
writing the first string, the second string, the third string, and a fourth string from the text information entry into a fourth array; and
writing the contents of the first array, the second array, the third array, and the fourth array into corresponding entries of the string level file.

7. The method of claim 4, comprising:
identifying, by the analysis device, a number of identical occurrences of an entry in the string level file; and
generating, by the analysis device, a summary file listing each entry and the associated number of identical occurrences of the entry in the string level file.

8. The method of claim 7, wherein applying the filter criteria to at least a portion of each text information entry of the source file table to identify one of the retained text entry and the excluded text entry, comprises applying, by the analysis device, filter criteria to the entries of the summary file to identify the at least one of the retained text entry and the excluded text entry.

9. The method of claim 1, comprising, in response to providing, as the key text items, the result file listing each retained text entry:
receiving, by the analysis device, a context command associated with a retained text entry of the result file;
accessing, by the analysis device, a text information entry in the source file table associated with the retained text entry of the result file;
accessing, by the analysis device, the line information entry in the source file table associated with the text information entry; and
providing, by the analysis device, context output associated with the line information entry, the context output including the line information entry and at least one of a previous line information entry and a subsequent line information entry of the source file table.

11. The method of claim 1, wherein receiving the source file further comprises storing, by the analysis device, the source file in a memory location; and
following storing each line of the source file as a line information entry and a text information entry in the source file table, deleting, by the analysis device, the source file from the memory location.

11. An analysis device, comprising:
a controller having a memory and a processor, the controller configured to:
receive a source file from a user device, the source file including key text items;
store each line of the source file as a line information entry and a text information entry in a source file table;
apply a filter criteria to at least a portion of each text information entry of the source file table to identify one of a retained text entry and an excluded text entry; and
provide as the key text items a result file listing each retained text entry.

12. The analysis device of claim 11, wherein when storing each line of the source file as a line information entry and a text information entry in a source file table, the controller is configured to:
identify non-textual information in a line of the source file;
remove the identified non-textual information from the line of the source file;
store the line of the source file as the line information entry in the source file table; and
store the line absent the identified non-textual information as the text information entry in a source file table.

13. The analysis device of claim 11, wherein the controller is configured to:
receive header information associated with the source file;
compare each line of the source file with the header information; and
when a line of the source file corresponds to the header information, refrain from storing the line of the source file as a line information entry and as a text information entry in the source file table.

14. The analysis device of claim 11, wherein the controller is configured to:
write at least one string of the text information entry into at least one array; and
write the contents of the at least one array to a corresponding entry of a string level file.

15. The analysis device of claim 14, wherein when writing the at least string into the at least one array wherein the controller is configured to:
write a first string from the text information entry into a first array;
write the first string and a second string from the text information entry into a second array;
write the first string, the second string, and a third string from the text information entry into a third array;
write the first string, the second string, the third string, and a fourth string from the text information entry into a fourth array; and
write the contents of the first array, the second array, the third array, and the fourth array into corresponding entries of the string level file.

16. The analysis device of claim 15, wherein the controller is configured to repeat the steps of:
identifying the second string from the text information entry as a first string of the text information entry;
writing the first string from the text information entry into a first array;
writing the first string and a second string from the text information entry into a second array;
writing the first string, the second string, and a third string from the text information entry into a third array;
writing the first string, the second string, the third string, and a fourth string from the text information entry into a fourth array; and
writing the contents of the first array, the second array, the third array, and the fourth array into corresponding entries of the string level file.

17. The analysis device of claim 14, wherein the controller is configured to:
identify a number of identical occurrences of an entry in the string level file; and
generate a summary file listing each entry and the associated number of identical occurrences of the entry in the string level file.

18. The analysis device of claim 17, wherein when applying the filter criteria to at least a portion of each text information entry of the source file table to identify one of the retained text entry and the excluded text entry, the controller is configured to apply filter criteria to the entries of the summary file to identify the at least one of the retained text entry and the excluded text entry.

19. The analysis device of claim 11 wherein, in response to providing, as the key text items, the result file listing each retained text entry, the controller is configured to:
receive a context command associated with a retained text entry of the result file;
access a text information entry in the source file table associated with the retained text entry of the result file;
access the line information entry in the source file table associated with the text information entry; and
provide context output associated with the line information entry, the context output including the line information entry and at least one of a previous line information entry and a subsequent line information entry of the source file table.

20. The analysis device of claim 11, wherein when receiving the source file, the analysis device is further configured to store the source file in a memory location; and
following storing each line of the source file as a line information entry and a text information entry in the source file table, the analysis device is configured to delete the source file from the memory location.
